(19) United States
(12) Patent Application Publication
(10) Pub. No.: US 2008/0238082 A1
(43) Pub. Date: Oct. 2, 2008

(54) Article Including a Semi-Reflective Multilayer Interference Structure

(75) Inventors: Nathalie Vast, Mont Saint Eloi (FR); Pierre Doublet, Saint Brice (FR); Herle Carn, Paris (FR)

Correspondence Address: OLIFF & BERRIDGE, PLC, P.O. BOX 320850, ALEXANDRIA, VA, 22320-4850, US

(73) Assignee: ARJOWIGGINS SECURITY, Issy Les Moulineaux (FR)

(21) Appl. No.: 11/630,111

(22) PCT Filed: Jun. 23, 2005
(86) PCT No.: PCT/FR05/50485

§ 371 Date: May 5, 2008

(30) Foreign Application Priority Data
Jun. 23, 2004 (FR) 0451318

(51) Int. Cl. B42D 15/10

(52) U.S. Cl. 283/72

(57) ABSTRACT

The present invention relates to a document such as a bank note, including:
a plurality of juxtaposed interference semi-reflecting multilayer structures; and
a zone that is preferably transparent at least part in which there extends at least part of at least one of the multilayer interference structures, which structures are configured in such a manner that an observer can perceive a first color in reflection and a second color, different from the first, in transmission.

The present invention relates in particular to authenticating articles such as data media or packaging, for example.

A wide variety of authentication means have already been proposed, implementing the magnetic, electrical, or optical properties of certain materials. Proposals have been made in particular to use pigments presenting thermochromic or goniochromatic properties in bank notes, for example. U.S. Pat. No. 6,473,165 thus describes an example of a device for verifying the authenticity of a document by analyzing reflected light.

The invention seeks in particular to propose novel means enabling an article to be authenticated and that also provide a pleasing appearance effect, where appropriate.

In one of its aspects, the invention thus provides an article including:
a semi-reflecting multilayer interference structure; and
a zone that is preferably at least partially transparent in which the multilayer interference structure extends at least in part, the structure being configured in such a manner that an observer can perceive a first color in reflection and a second color, different from the first, in transmission.

The multilayer structure may serve in particular as authentication means, with it being easy for an observer and/or a suitable detector apparatus to observe the color change in reflection or in transmission. The detector apparatus may even analyze at least one of the transmission and reflection spectra, where appropriate, in order to determine whether they present a predefined spectral signature.

In addition, and if so desired, the multilayer structure makes it possible to produce colors that are relatively saturated, which can contribute to the appearance of the article.

Furthermore, the color change can be fun to play with, which can make the article more attractive.

The flexibility of the multilayer structure makes it possible to provide a wide variety of articles therewith, regardless of whether they are flexible or rigid.

By way of example, the article may be a packaging device, e.g. a receptacle or a box or a data medium, e.g. a document of value or a security document, in particular a bank note, a label, a security thread, a foil, or an optical disk, this list not being limiting. The document may in particular contain papermaking fiber.

When the packaging device contains a fluid, the color observed in reflection or in transmission may depend on how full it is of said fluid, which can provide an additional appearance effect.

The multilayer structure may be carried by a transparent film, or in a variant by a wall of the article itself, in particular if said wall is made of a translucent or transparent plastics material, as may be true, for example, for an optical disk or a receptacle containing a fluid.

The article may include a plurality of juxtaposed semi-reflecting multilayer interference structures, configured to present different colors when observed simultaneously in reflection or in transmission.

By way of example, the various multilayer structures may be juxtaposed on a common face of the article so as to create patterns, e.g. a checkerboard or some other pattern.

Two juxtaposed multilayer structures may include one or more layers in common, if so desired.

In a variant, the multilayer structures need have no layer in common.

The multilayer structure is preferably made by a vacuum deposition technique, and regardless of the technique used, it may comprise, for example: a layer of a metal; and at least one layer of a metal oxide; and in particular a plurality of layers of different metal oxides, which layers may present thicknesses that are different.

The multilayer structure may comprise more than three or more than five layers, e.g. it may comprise eight layers. Where appropriate, the multilayer structure may include at least two layers of different metallic oxides or metals.

The color in reflection and/or in transmission of the multilayer structure may be selected as a function of information carried by the article, e.g. it may be selected as a function of the color of a distinctive sign used as a trademark by the manufacturer of the article, and possibly present elsewhere on the article.

When the article is a document, it may, for example, comprise at least one fiber layer, e.g. a layer of papermaking fiber, and in particular of cellulose. The multilayer structure may be carried by a film extending in at least one window of the document, for example.

When the document has a plurality of semi-reflecting multilayer interference structures, and where appropriate, they may create a plurality of colors within a common window of the document, when the document is observed in reflection and in transmission.

In a variant, these multilayer structures create different colors in different windows of the document when the document is observed in reflection and in transmission.

The article may also include a layer of adhesive, which may be advantageous, in particular when the article is a data medium such as a label or a visa.

The multilayer structure may be configured in such a manner as to be substantially non-goniochromatic.

The multilayer interference structure may be made opaque in transmission in places, partially or totally perforated.

The article may include an optionally uniform background, that is optionally colored, extending behind the multilayer structure. The background may be arranged in such a manner as to create alternating color effects. In particular, the article may include printing behind the multilayer structure, in particular printing using a magnetic ink or a black ink or a reflecting ink. Where appropriate, the ink is deposited on the multilayer structure itself, or on a face of a document or a packaging device covered in the multilayer structure. The multilayer structure may also include partial demetallization, e.g. in order to cause writing to appear as a negative.

The printing may include at least one alphanumeric character.

The invention also provides a method of authenticating an article, in which the color of the multilayer structure is observed in reflection and in transmission, and in which the authenticity of the article is evaluated as a function of at least one item of information associated with the observed color change.

The invention also provides a method of authenticating an article, in which at least one of the transmission spectrum and the reflection spectrum of the multilayer structure is measured and compared with a reference spectrum.

Independently or in combination with the above, the invention also provides a range of documents of value in which a color is associated with each document of the range, the color being obtained by an multilayer interference structure.

The multilayer structure may be arranged on the document in such a manner as to visible in reflection and/or transmission. The multilayer structure may be placed in particular in front of an opaque zone. The multilayer structure may be deposited on a face of a substrate, e.g. such as a film of transparent thermoplastic material coated on its opposite face by a reflecting coating. The multilayer structure may also be opaque, with its opacity being obtained for example by increasing the thickness of the layer of the multilayer structure adjacent to the substrate.

The multilayer structure may also be placed on the document in such a manner as to cover at least a portion thereof that is opaque at least in part, in particular a portion that is completely opaque. The covered portion may include printing, in particular printing that conveys information, e.g. printing using a magnetic ink and/or printing using black or colored ink on a white or colored background. The color of the ink may be associated with using magnetic pigments. The color observed in front of a black background may be different from the color observed in front of a background that is white or colored.

In another of its aspects, the invention also provides a digital data medium including:
a semi-reflecting multilayer interference structure; and
a zone that is at least partially transparent in which the multilayer interference structure extends at least in part, the structure being configured in such a manner that an observer can perceive a first color in reflection and a second color, different from the first, in transmission.

In another of its aspects, the invention also provides a receptacle including:
a semi-reflecting multilayer interference structure; and
a zone that is at least partially transparent in which the multilayer interference structure extends at least in part, the structure being configured in such a manner that an observer can perceive a first color in reflection and a second color, different from the first, in transmission.

The invention can be better understood on reading the following detailed description of non-limiting embodiments thereof, and on examining the accompanying drawings, in which:

FIG. 1 is a diagram of an example of a film coated in a multilayer structure of the invention;

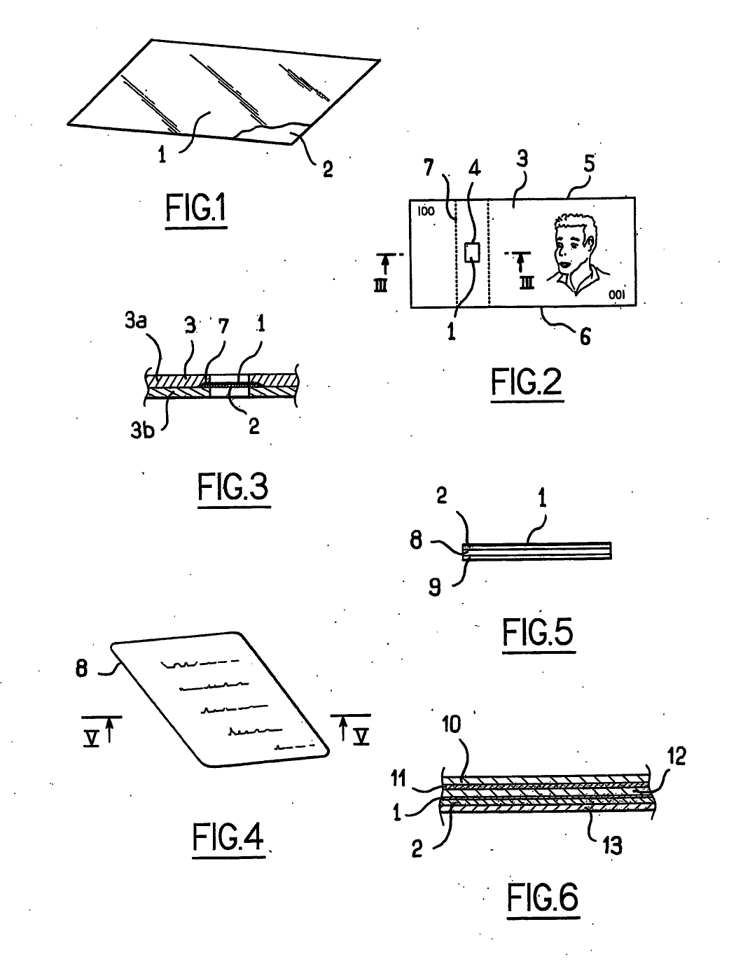

FIG. 2 shows a document of value including a window in which the multilayer structure is visible;

FIG. 3 is a diagrammatic and fragmentary section on III-III of FIG. 2;

FIG. 4 is a diagrammatic view of a label carrying a multilayer structure of the invention;

FIG. 5 is a section on V-V of FIG. 4;

FIG. 6 shows a multilayer structure carried detachably by a support strip;

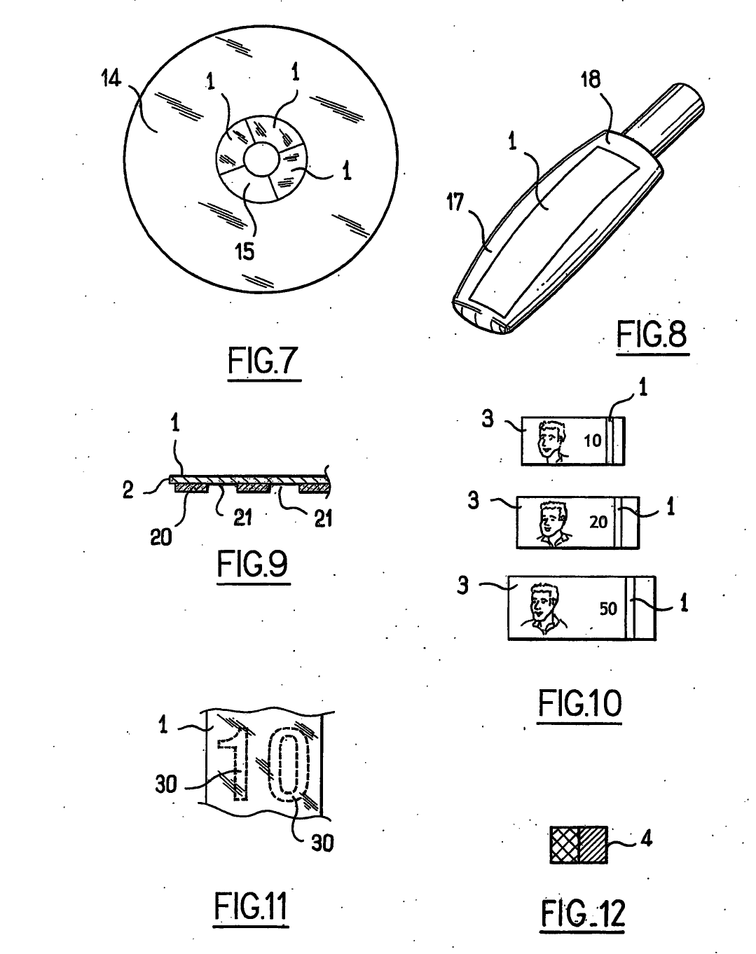

FIG. 7 shows a CDROM provided with multilayer structures in accordance with the invention;

FIG. 8 shows a receptacle presenting a multilayer structure made in accordance with the invention;

FIG. 9 is a diagram showing the possibility of making the multilayer structure opaque in places;

FIG. 10 shows a range of documents of value associated with different multilayer structures;

FIG. 11 shows the possibility of printing behind the multilayer structure; and

FIG. 12 is a diagram showing a window of a document presenting two colors.

In the drawings, the relative proportions of different elements are not always to scale, for reasons of clarity.

FIG. 1 is a diagram showing a multilayer structure 1 made in accordance with the invention and carried by an underlying support film 2, the film 2 being transparent in the example described.

The multilayer structure 1 is a semi-reflecting interference filter capable of presenting a first color when observed in transmission, when illuminated in white light, and a second color when observed in reflection, e.g. in front of a dark background.

The multilayer structure is made up of alternating layers of low refractive index and of high refractive index, the low index layers being constituted by layers of a dielectric, for example, and the high index layers by layers of a metal.

The refractive indices of the various layers and their respective thicknesses are selected by applying the well-known theory of interference filters, in such a manner as to cause the spectral reflectance of the multilayer structure to present the desired properties. By way of example, the various layers may be selected so that at least one of the reflectance spectrum and the transmission spectrum of the structure corresponds substantially to a reference spectrum, which can subsequently be used as a reference signature in an authentication method.

By way of example, the multilayer structure may be blue in transmission and an orangey-gold color in reflection. Naturally other colors could be selected.

The multilayer structure may comprise layers made out of materials selected from the following non-limiting list: MgF₂, CeF₃, ZnS, ZnSe, Si, Ge, Te, SiO₂, Fe₂O₃, Pt, Va, Al₂O₃, MgO, Y₂O₃, S₂O₃, SiO, HfO₂, ZrO₂, CeO₂, Nb₂O₅, Ta₂O₅, TiO₂, Ag, Al, Au, Cu, Rb, Ti, Ta, W, Zr, Zn, and mixtures and oxides thereof.

The various layers may be deposited using known vacuum deposition techniques, e.g. evaporation techniques, ion deposition techniques, sputtering, e.g. radiofrequency (RF) sputtering, ion beam sputtering, or laser sputtering, chemical vapor deposition (CVD), possibly assisted by a plasma (PCVD), by ionized cluster beam (ICB), by epitaxy, in particular by molecular beam epitaxy, by ion bombardment, this list not being limiting.

Examples of vacuum deposition techniques are described in particular in U.S. Pat. No. 6,524,381.

The support film 2 may be a film of transparent thermoplastic material, e.g. of polyester. The layer of the multilayer structure that is in contact with the support film 2 may be a layer of a metallic oxide, for example.

Various articles may be provided with a multilayer structure in accordance with the invention.

By way of example, FIG. 2 shows a security document 3 including a window 4 in which the multilayer structure 1 extends.

By way of example, the window 4 may be made in two paper plies 3a and 3b, the film 2 carrying the multilayer structure 1 extending for example from one edge 5 of the document 3 to the opposite edge 6 in the form of a strip 7 that is sandwiched between the two plies 3a and 3b.

The multilayer structure 1 may also cover a data medium 8 such as a label, as shown in FIGS. 4 and 5. On one face the label has the film 2 carrying the multilayer structure 1, and on its opposite face it has, at least in places, an adhesive layer 9 enabling it to be secured on an article that preferably presents at least one transparent zone.

The multilayer structure may also be used in making a foil, as shown in FIG. 6, such a foil comprising a support strip 10, a release strip 11, a protective varnish 12, the multilayer structure 1 and the associated film 2, and a layer of an adhesive 13, e.g. a hot-activatable adhesive.

The foil is applied on the article that is to be covered at least in part by the multilayer structure. The transfer may be performed by applying heat and pressure, the assembly constituted by the varnish 12, the multilayer structure 1, the film 2, and the adhesive 13 becoming detached from the support strip 10 coated in the release layer 11.

FIG. 7 shows a CDROM 14 having a transparent central portion 15 on which a plurality of multilayer structures 1 has been deposited, these structures presenting different optical properties so as to create a plurality of colors when the CDROM is observed in reflection, and also a plurality of colors when the CDROM is observed in transmission.

The various multilayer structures 1 are juxtaposed in the form of quadrants in the example of FIG. 7, but naturally other arrangements could be devised without going beyond the ambit of the present invention.

In the example of document 3, the film 2 may receive a plurality of multilayer structures 1 presenting different optical structures so as to create a plurality of colors in a single window 4 when the document is observed in reflection, and also a plurality of colors when the document is observed in transmission, as shown in FIG. 12.

In the example of FIG. 8, the multilayer structure 1 is deposited on an outside face 17 of the transparent wall 18 of a receptacle containing a fluid. Where appropriate, the wall 18 has only one transparent window, e.g. being covered by printing or a label. Furthermore, the wall 18 may be flexible, e.g. being made of a transparent thermoplastic material. The wall 18 may also be relatively rigid, with the fluid then being extracted, e.g. by means of a pump.

When the material constituting the wall 18 makes this possible, the multilayer structure 1 may be deposited directly on said wall, by one of the above-mentioned deposition techniques, or in a variant it may be deposited on the support film 2, which film is subsequently secured to the wall 18 of the receptacle, e.g. using an adhesive or heat-sealing.

When the receptacle is full, the multilayer structure 1 may appear in a certain color in reflection. As the receptacle empties progressively, the portion of the multilayer structure 1 situated below the level of the fluid contained in the receptacle may continue to appear in the same color, while its portion situated above the level of the fluid may appear in some other color.

FIG. 9 shows the possibility of placing an at least partially opaque background 20 behind the multilayer structure 1, said background possibly being black, and for example being interrupted by gaps so as to enable the multilayer structure 1 to be observed in transmitted light in said gaps 21.

It is thus possible to create alternating color effects, e.g. an alternation of blue and orange colors, the blue color being observed in front of the background 20.

FIG. 10 shows a range of documents of value 3, e.g. different denominations of bank note. Each denomination or denomination range may be associated with a specific multilayer structure 1 so that the user can perceive a given color in reflection for each denomination. For example, there may be one color for low value denominations and another for high value denominations.

By way of example, the multilayer structure 1 may be present on a security thread or patch and may cover all or part of one face of the document 3.

The multilayer structure 1 may cover a zone of the document that is opaque in full or in part.

The zone covered by the multilayer structure 1 may present a color that is uniform or it may present at least two regions of different colors, e.g. at least one pale color and at least one dark color so that the multilayer structure appears to be non-uniform in color.

When the multilayer structure 1 is placed in front of a uniform background, it may be constituted by a reflecting background, e.g. in the form of a metallic deposit, or it may be white or black.

Where appropriate, the multilayer structure 1 may be made in such a manner as to be opaque, its color thus being observable in transmission only, being independent of the zone of the document 3 that is covered by the multilayer structure.

The multilayer structure 1 may optionally cover printing, e.g. comprising at least one alphanumeric character 30, and as shown in FIG. 11. By way of example, this printing may be performed using a black ink on a white background, so that the region of the multilayer structure 1 that overlies the printed character appears to have a color that is different from that that overlies the white background.

Naturally, the invention is not limited to the examples described above.

In all of these examples, it is possible to add at least one conventional security element to the document or the packaging device, where the security element may be constituted, for example, by an optically variable device or a device suitable for revealing an attempt at falsification.

The multilayer structure 1 may be demetallized in part, where such partial demetallization makes it possible, for example, to reveal alphanumeric characters when the multilayer structure 1 is observed in transmission. This or these character(s) may appear as positive or negative writing.

The characteristics of the various embodiments described above may be combined with one another.

In particular, in the examples of FIGS. 1 to 6 and 8 to 11, it is possible to provide a plurality of multilayer structures that are juxtaposed and of different colors, in the manner described above with reference to FIG. 7.

Throughout the description, including in the claims, the term “comprising a” should be understood as being synonymous with “comprising at least one”, unless specified to the contrary.

1.-21. (canceled)

22. A document comprising:
a plurality of juxtaposed semi-reflecting multilayer interference structures; and
a zone, at least part of at least one of the multilayer interference structures extending into at least part of the zone, which structures are configured so that an observer can perceive a first color in reflection and a second color, different from the first, in transmission.

23. A document according to claim 22, wherein the zone is transparent.

24. A document according to claim 22, wherein the document is flexible.

25. A document according to claim 22, wherein the at least one of the multilayer structures is carried by a flexible film.

26. A document according to claim 25, wherein the flexible film is transparent.

27. A document according to claim 22, wherein the multilayer structures are juxtaposed on a common face of the document.

28. A document according to claim 22, wherein at least one of the multilayer structures is made by a vacuum deposition technique.

29. A document according to claim 22, wherein at least one of the color in reflection and in transmission of the at least one of the multilayer structures is selected as a function of information carried by the document.

30. A document according to claim 29, wherein the document is a bank note and the information is the value of a denomination of the bank note.

31. A document according to claim 22, wherein the document includes at least one fiber layer.

32. A document according to claim 22, wherein the at least one of the multilayer structures is carried by a film extending in at least one window of the document.

33. A document according to claim 22, wherein the juxtaposed multilayer interference structures create a plurality of colors within a common window of the document when the document is observed in reflection or in transmission.

34. A document according to claim 22, wherein at least one of the multilayer interference structures is made opaque in transmission in places.

35. A document according to claim 22, wherein a non-uniform background extends behind at least one of the multilayer structures so as to create alternating color effects.

36. A document according to claim 22, wherein at least one of the multilayer structures lies in front of printing.

37. A document according to claim 36, wherein the printing is a printing of at least one alphanumeric character.

38. A digital data medium comprising:
a semi-reflecting multilayer interference structure; and
a zone that is at least partially transparent, at least part of the multilayer interference structure extending into the zone, the structure being configured so that an observer can perceive a first color in reflection and a second color, different from the first, in transmission.

39. A medium according to claim 38, being an optical disk.

40. A medium according to claim 38, comprising a plurality of juxtaposed multilayer interference structures.

41. A medium according to claim 40, being a disk having a transparent central portion, the plurality of multilayer structures being deposited on the transparent central portion.

42. A medium according to claim 41, the various multilayer structures being juxtaposed in the form of quadrants.

43. A receptacle comprising:
a semi-reflecting multilayer interference structure; and
a zone that is at least partially transparent, at least part of the multilayer interference structure extending into the zone, the structure being configured so that an observer can perceive a first color in reflection and a second color, different from the first, in transmission.

44. A receptacle according to claim 43, being rigid.

45. A receptacle according to claim 44, including at least one flexible wall.

46. A receptacle according to claim 45 comprising a plurality of juxtaposed semi-reflecting multilayer interference structures.
